(19) United States
(12) Patent Application Publication
(10) Pub. No.: US 2026/0323455 A1
(43) Pub. Date: Oct. 15, 2026

(54) METHOD FOR DUAL-CLOUD SIM CARD COMMUNICATION, ELECTRONIC DEVICE, AND MACHINE-READABLE STORAGE MEDIUM

(71) Applicant: Shanghai TUGE Data Technologies Co., Ltd., Shanghai (CN)

(72) Inventors: Tianming LV, Shanghai (CN); Kaihang WANG, Shanghai (CN); Hao ZHOU, Shanghai (CN)

(73) Assignee: Shanghai TUGE Data Technologies Co., Ltd., Shanghai (CN)

(21) Appl. No.: 18/996,947

(22) PCT Filed: May 18, 2023
(86) PCT No.: PCT/CN2023/095005

§ 371 Date: Jan. 17, 2025

(30) Foreign Application Priority Data
Jul. 26, 2022 (CN) 202210881024.7

(51) Int. Cl. H04W 36/30; H04W 12/45; H04W 36/14

(52) U.S. Cl. CPC H04W 36/30; H04W 12/45; H04W 36/14

(57) ABSTRACT

A method for dual-cloud subscriber identification module (SIM) card communication method includes: acquiring card information of a second cloud SIM card from a cloud communication server, wherein the second cloud SIM card and a first authentication module home to a same network operator; authenticating the card information of the second cloud SIM card based on the first authentication module, and detaching the first authentication module in response to a successful authentication; acquiring card information of a first cloud SIM card from the cloud communication server, wherein the first cloud SIM card and a second authentication module home to a same network operator; and authenticating card information of the first cloud SIM card based on the second cloud SIM card, and carrying out the dual-cloud SIM card communication using the first cloud SIM card and the second cloud SIM card in response to a successful authentication.

### CROSS REFERENCE TO THE RELATED APPLICATIONS

This application is the national phase entry of International Application No. PCT/CN2023/095005, filed on May 18, 2023, which is based upon and claims priority to Chinese Patent Application No. 202210881024.7, filed on Jul. 26, 2022, the entire contents of which are incorporated herein by reference.

### TECHNICAL FIELD

Embodiments of the present disclosure relate to the technical field of information communications, and in particular, relate to a method for dual-cloud SIM card communication, an electronic device, and a machine-readable storage medium.

### BACKGROUND

Currently, a dual-SIM dual-standby electronic device supports subscriber identification module (SIM) cards from different operators to access different network services. Typically, one SIM card is used as a primary card which is from a first operator for providing data and voice services, and the other SIM card is registered with a 2G, 3G, 4G, or 5G network. One of these networks may be manually selected by a user or automatically selected by a terminal to provide data or voice services. The electronic device is equipped with a primary card switching threshold. In the case that the communication indicators of the first network from the first operator in the current area fall below the threshold, the data channel is switched to the other SIM card, enabling network switching between the two SIM cards in the electronic device. However, this method relies on the network environment of the physical cards and fails to combine the local network conditions for optimized network configuration.

### SUMMARY

Embodiments of the present disclosure provide a method for dual-cloud SIM card communication, an electronic device, and a machine-readable storage medium. Two SLIM cards are deployed in a primary-backup configuration in the electronic device, and dual-path protection is provided for users.

Some embodiments of the present disclosure provide a method for dual-cloud SIM card communication, applicable to an electronic device, wherein the electronic device is equipped with a first authentication module and a second authentication module. The method includes:
acquiring card information of a second cloud SIM card from a cloud communication server, authenticating the card information of the second cloud SIM card based on a first authentication module, and detaching the first authentication module in response to a successful authentication on the card information of the second cloud SIM card, wherein the second cloud SIM card and the first authentication module home to a same network operator;
acquiring card information of a first cloud SIM card from the cloud communication server, wherein the first cloud SIM card and the second authentication module home to a same network operator; and
authenticating card information of the first cloud SIM card based on the second cloud SIM card, and carrying out the dual-cloud SIM card communication using the first cloud SIM card and the second cloud SIM card in response to a successful authentication on the card information of the first cloud SIM card.

In some embodiments, authenticating the card information of the second cloud SIM card using the first authentication module includes:
sending a first authentication request to a card pool based on data of the first authentication module to acquire an authentication result for the card information of the second cloud SIM card from the card pool based on the data of the first authentication module; and
correspondingly, authenticating the card information of the first cloud SIM card based on the second cloud SIM card comprises:
sending a second authentication request to the card pool based on data of the second cloud SIM card to acquire an authentication result for the card information of the first cloud SIM card from the card pool.

In some embodiments, carrying out the dual-cloud SIM card communication using the first cloud SIM card and the second cloud SIM card includes:
monitoring first communication quality data of the first cloud SIM card and second communication quality data of the second cloud SIM card; and
carrying out data communication using the first cloud SIM card in a case that the first communication quality data is superior over the second communication quality data, or carrying out data communication based on the second cloud SIM card in a case that the first communication quality data is not superior over the second communication quality data.

In some embodiments, the method further includes:
switching a data link to the second cloud SIM card in response to monitoring that the first communication quality data of the first cloud SIM card is abnormal;
acquiring card information of a third cloud SIM card from the cloud communication server, and sending a third authentication request to the card pool based on the data of the second cloud SIM card to acquire an authentication result for the card information of the third cloud SIM card from the card pool; and
carrying out the dual-cloud SIM card communication based on the third cloud SIM card and the second cloud SIM card in response to the authentication result for the card information of the third cloud SIM card indicating a successful authentication.

In some embodiments, in a case that the card information of the first cloud SIM card is successfully authenticated, the method further comprises: acquiring, based on a data channel of the first cloud SIM card, the second authentication module homing to the same network operator as the first cloud SIM card from the cloud communication server; and
sending the third authentication request to the card pool based on the data of the second cloud SIM card includes:
sending the third authentication request to the card pool based on the data of the second cloud SIM card and the second authentication module to acquire the authentication result for the card information of the third cloud SIM card from the card pool based on the second authentication module.

In some embodiments, carrying out the dual-cloud SIM card communication based on the third cloud SIM card and the second cloud SIM card includes:
monitoring third communication quality data of the third cloud SIM card and the second communication quality data of the second cloud SIM card; and
carrying out data communication based on the third cloud SIM card in a case that the third communication quality data is superior over the second communication quality data, or carrying out data communication based on the second cloud SIM card in a case that the third communication quality data is not superior over the second communication quality data.

In some embodiments, the first authentication module and the second authentication module include, but are not limited to, authentication modules for a physical SIM card, an eSIM card, and a soft SIM card.

In some embodiments, the first cloud SIM card and the second cloud SIM card home to different network operators.

Some embodiments of the present disclosure further provide an electronic device. The electronic device includes:
a first acquisition module, configured to acquire card information of a second cloud SIM card from a cloud communication server, wherein the second cloud SIM card and a first authentication module home to a same network operator;
the first authentication module, configured to authenticate card information of the second cloud SIM card acquired by the first acquisition module, and detach the first authentication module in response to a successful authentication on the card information of the second cloud SIM card;
a second acquisition module, configured to acquire card information of a first cloud SIM card from the cloud communication server, wherein the first cloud SIM card and a second authentication module home to a same network operator;
the second authentication module, configured to authenticate, based on the second cloud SIM card, the card information of the first cloud SIM card acquired by the second acquisition module; and
a dual-cloud SIM card communication module, configured to carry out the dual-cloud SIM card communication using the first cloud SIM card and the second cloud SIM card in response to a successful authentication on the card information of the first cloud SIM card by the second authentication module.

In some embodiments, the first authentication module is configured to send a first authentication request to a card pool based on data of the first authentication module to acquire an authentication result for the card information of the second cloud SIM card from the card pool based on the data of the first authentication module; and
correspondingly, the second authentication module is configured to send a second authentication request to the card pool based on data of the second cloud SIM card to acquire an authentication result for the card information of the first cloud SIM card from the card pool.

In some embodiments, the dual-cloud SIM card communication module includes a communication quality detection unit, and a dual-cloud SIM card communication unit; wherein
the communication quality detection unit is configured to monitor first communication quality data of the first cloud SIM card and second communication quality data of the second cloud SIM card; and
the dual-cloud SIM card communication unit is configured to carry out data communication using the first cloud SIM card in a case that the first communication quality data is superior over the second communication quality data, or carry out data communication based on the second cloud SIM card in a case that the first communication quality data is not superior over the second communication quality data.

In some embodiments, the dual-cloud SIM card communication module further includes a failure handling and communication unit, configured to switch a data link to the second cloud SIM card in response to the communication quality detection unit monitoring that the first communication quality data of the first cloud SIM card is abnormal; and
correspondingly, the electronic device further includes a third acquisition module and a third authentication module; wherein
the third acquisition module is configured to acquire card information of a third cloud SIM card from the cloud communication server;
the third authentication module is configured to send a third authentication request to the card pool based on data of the second cloud SIM card to acquire an authentication result for the card information of the third cloud SIM card from the card pool; and
the failure handling and communication unit is further configured to carry out the dual-cloud SIM card communication based on the third cloud SIM card and the second cloud SIM card in response to the authentication result for the card information of the third cloud SIM card indicating a successful authentication.

In some embodiments, the first cloud SIM card and the second cloud SIM card home to different network operators.

In some embodiments, the first authentication module and the second authentication module include, but are not limited to, authentication modules for a physical SIM card, an eSIM card, and a soft SIM card.

Some embodiments of the present disclosure further provide a device for dual-cloud SIM card communication. The device includes:
a processor, an encryptor, a memory, and one or more computer programs that are stored in the memory and runnable on the processor; wherein the one or more computer programs, when loaded and run by the processor, cause the processor to perform the method for dual-cloud SIM card communication as described above.

Some embodiments of the present disclosure provide a machine-readable storage medium storing one or more executable instructions, wherein the one or more executable instructions, when loaded and executed by a machine, cause the machine to perform the method for dual-cloud SIM card communication as described above.

Apparently, in the above technical solutions, two cloud SIM cards are assigned to the electronic device for communication, two different operator networks are assigned to the electronic device, and the two networks are in a primary-backup configuration. This arrangement ensures that, in the case of international roaming or crossing multiple national boundaries, two optimal network operators are dynamically selected to provide network services. In this way, communication roaming costs are reduced, and network reliability and communication quality are improved. In fixed environments, more than two operator networks may be constantly detected, and two optimal networks are selected as primary and backup networks. A primary network is selected based on the performance of the networks in different time periods, such that optimal communication quality and reliability are achieved.

### BRIEF DESCRIPTION OF THE DRAWINGS

For clearer descriptions of the technical solutions according to the specific embodiments of the present disclosure, hereinafter brief description is given with reference to the accompanying drawings for illustrating the embodiments and the related art. However, those skilled in the art should understand that the accompanying drawings are merely for describing some examples of the present disclosure, but are not intended to limit the scope of the present disclosure.

FIG. 1 is a schematic flowchart of a method for dual-cloud SIM card communication on a server according to some embodiments of the present disclosure;

FIG. 2 is a schematic diagram of an authentication process in the case that a cloud SIM card of dual cloud SIM cards functions normally according to some embodiments of the present disclosure;

FIG. 3 is a schematic flowchart of monitoring and switching a method for cloud SIM card communication by a dual-cloud SIM card network according to some embodiments of the present disclosure;

FIG. 4 is a schematic flowchart of a registration process of dual-cloud SIM cards according to some embodiments of the present disclosure;

FIG. 5 is a schematic structural diagram of an electronic device according to some embodiments of the present disclosure;

FIG. 6 is a schematic structural diagram of an electronic device according to some embodiments of the present disclosure;

FIG. 7 is a schematic structural diagram of a device for dual-cloud SIM card communication according to some embodiments of the present disclosure.

### DETAILED DESCRIPTION OF THE EMBODIMENTS

The technical solutions according to embodiments of the present disclosure are clearly and thoroughly described hereinafter with reference to the accompanying drawings illustrating the embodiments of the present disclosure. Those skilled in the art should understand that the embodiments described herein are merely exemplary ones, but are not all the embodiments of the present disclosure. Based on the embodiments in the present disclosure, those skilled in the art may make any suitable modifications or variations to derive all other embodiments.

Currently, in a dual-SIM dual-standby electronic device, both SIM cards remain in a standby mode, and data or voice communication is carried out on one SIM card. In the case that the communication indicators of the first network from the first operator in the current area fall below the switching threshold of the primary SIM card (which may be configured as a primary or backup SIM card), the data channel is switched to the other SIM card, which carries out data communication over the second network. This enables network switching between the two SIM cards in the electronic device. However, this method relies on the network environment of the physical cards and fails to combine the local network conditions for optimized network configuration.

In view of the above, some embodiments of the present disclosure provide a dual-cloud SIM card communication solution. The solution involves an electronic device and a cloud communication server. At least two authentication modules are configured on the electronic device, and the cloud communication server provides at least two cloud SIM cards for the electronic device. A first authentication module and a second authentication module may be authentication modules for a physical SIM card, an eSIM card, and a soft SIM card, or may be other conventional authentication modules or authentication card supporting the future technologies. For example, in the case that a physical SIM card is installed on the device, the authentication module is an authentication module of the physical SIM card; and in the case that an eSIM card is installed on the device, the authentication module is an authentication module of the eSIM card; and in the case that a soft SIM card is installed on the device, the authentication module an authentication of the soft SIM card. For simplicity, in describing the technical solutions of the present disclosure, the term “SIM card” is used uniformly to refer to the above-mentioned forms, which is the most commonly used term.

In the technical solutions according to the present disclosure, the two authentication modules on the device are configured with a primary-backup relationship. The primary-backup relationship may be defined manually and is referred to as the primary SIM card and the backup SIM card in the electronic device. Likewise, a primary-backup relationship may also be defined for the cloud SIM cards provided by the cloud communication server a primary cloud SIM card and a backup cloud SIM card, such that where the primary cloud SIM card encounters abnormal data, the data link is switched to the backup cloud SIM card. The data channel of the backup cloud SIM card retrieves from the cloud communication server a new primary cloud SI card (hereinafter referred to as a replacement primary cloud SIM card) to replace the replace the original primary cloud SIM card. The replacement primary cloud SIM card is then registered and authenticated. The replacement primary cloud SIM card and the backup cloud SIM card undergo a network quality evaluation, and the network with the optimal quality is selected as a primary network. During use, the replacement primary cloud SIM card and the backup cloud SIM card form a primary-backup relationship. The replacement primary cloud SIM card, the original primary cloud SIM card, and the backup cloud SIM card may home to different operators.

In the embodiments of the present disclosure, dual-cloud SIM cards are used for communication, such that the cloud SIM card with the optimal network quality provides data services within the same time period. Where a failure occurs to one cloud SIM card during communication, the electronic device is switched to the other cloud SIM card, such that data transmission is not interrupted. By using dual cloud SIM cards as mutual backups, the reliability of data services is significantly improved.

In practical applications, the primary and backup cloud SIM cards corresponding to the primary and backup SIM cards in the electronic device may be from the same network operator or from different network operators. In the case that the dual cloud SIM cards are from different network operators, mutual backups between networks may be achieved, and hence the reliability of data services is further enhanced.

The above technical solutions are described in detail hereinafter with reference to specific embodiments.

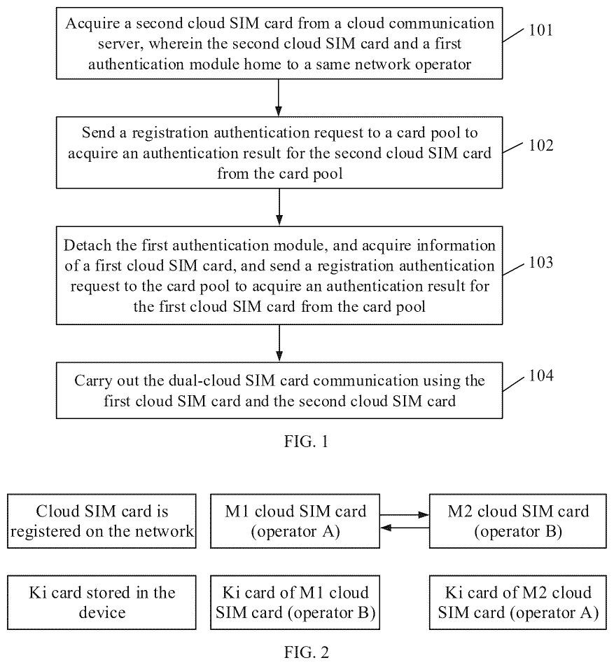

FIG. 1 is a schematic flowchart of a method for dual-cloud SIM card communication on a server according to some embodiments of the present disclosure.

In the embodiments of the present disclosure, the electronic device is equipped with a first authentication module and a second authentication module. The first authentication module corresponds to a SIM card which is referred to as a first SIM card (hereinafter referred to as an M1 cloud SIM card). The second authentication module corresponds to a SIM card which is referred to as a second SIM card (hereinafter referred to as an M2 cloud SIM card). The first SIM card and the second SIM card are respectively used as the primary SIM card and the backup SIM card.

In the embodiments of the present disclosure, the first authentication module is referred to as a Ki card of the M1 cloud SIM card, and the second authentication module is referred to as a Ki card of the M2 cloud SIM card. The second authentication module may assist the first cloud SIM card in completing authentication when the second cloud SIM card encounters a failure.

In the embodiments of the present disclosure, the authentication modules include, but are not limited to, authentication modules for a physical SIM card, an eSIM card, and a soft SIM card. The authentication modules are configured to send or transmit authentication information of the cloud SIM cards from the electronic device. For example, the authentication modules send authentication requests for the cloud SIM cards to the card pool, receive authentication responses calculated by the card pool, and report measurement information where data connections of the cloud SIM cards fail. The card pool in the cloud communication server stores a plurality of cloud SIM cards. These cloud SIM cards are assigned by the card pool to electronic devices to establish data connections in target networks.

Hereinafter, the processes that the electronic device acquires dual cloud SIM cards from the cloud communication server, registers and authenticates the dual cloud SIM cards using the card pool, and enables dual-cloud SIM card communication are described.

In step 101, an electronic device acquires a second cloud SIM card from a cloud communication server, wherein the second cloud SIM card and a first authentication module home to a same network operator.

Specifically, the electronic device acquires information of a cloud SIM card that is registered with the same operator as a Ki card of an M1 cloud SIM card from the cloud communication server over a data channel established by the M1 cloud SIM card. The cloud SIM card allows for registration of an M2 cloud SIM card, which is referred to as a second cloud SIM card.

In step 102, the electronic device sends a registration authentication request to a card pool to acquire an authentication result for the second cloud SIM card from the card pool.

In the case that the authentication is successful, step 103 is performed; and otherwise, the process ends.

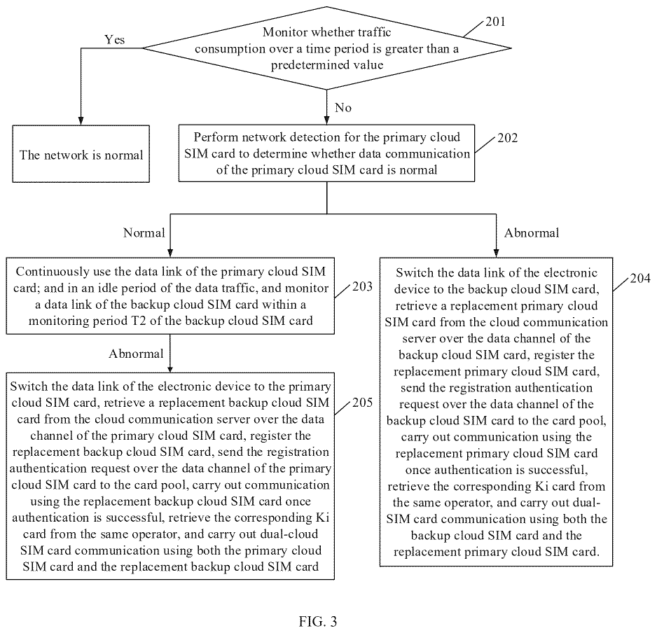

Referring to a schematic authentication diagram in the case that the dual cloud SIM cards are normal as illustrated in FIG. 2, in this step, the registration authentication request is sent to the card pool over the data channel of the M1 cloud SIM card, and authentication response data returned by the card pool is sent to the network over the M2 cloud SIM card to complete registration of the second cloud SIM card. The second cloud SIM card and the Ki card of the M1 cloud SIM card home to the same operator.

In step 103, the first authentication module is detached, and the electronic device acquires information of a first cloud SIM card, and sends a registration authentication request to the card pool to acquire an authentication result for the first cloud SIM card from the card pool.

Detachment means deregistering a SIM card from the network, and the SIM card is either deactivated on the terminal or removed. In the case that the authentication is successful, step 104 is performed; and otherwise, the process ends.

In this step, upon successful registration and authentication of the second cloud SIM card, the electronic device acquires the information of the first cloud SIM card over a data channel established by the second cloud SIM card, sends the registration authentication request to the card pool over the second data channel of the second cloud SIM card, and sends the authentication response data returned by the card pool to the network over the M1 cloud SIM card, such that registration of the first cloud SIM card is completed.

In this step, the Ki card of the M1 cloud SIM card is detached, and card information of the Ki card is stored in the electronic device.

In step 104, the dual-cloud SIM card communication is carried out using the first cloud SIM card and the second cloud SIM card.

In this step, upon registration of the first cloud SIM card, a Ki card of the M2 cloud SIM card homing to the same operator as the first cloud SIM card is acquired from the cloud communication server. In the embodiments of the present disclosure, the Ki card of the second M2 cloud SIM card is referred to as a second authentication card of the M2 cloud SIM card. The second authentication module corresponds to the M2 cloud SIM card, and is capable of assisting the first cloud SIM card in completing authentication when the second cloud SIM card encounters a failure.

Specifically, carrying out the dual-cloud SIM card communication using the first cloud SIM card and the second cloud SIM card includes:
monitoring first communication quality data of the first cloud SIM card and second communication quality data of the second cloud SIM card, and carrying out data communication using the first cloud SIM card in the case that the first communication quality data is superior over the second communication quality data (or data reflecting a better communication quality of the first cloud SIM card is more than data reflecting a better communication quality of the second cloud SIM card), or carrying out data communication based on the second cloud SIM card in the case that the first communication quality data is not superior over the second communication quality data.

As illustrated in FIG. 3, some embodiments of the present disclosure further provide a method flowchart for monitoring a dual-cloud SIM card communication network and carrying out cloud SIM card switching communication when a communication failure is detected.

In the embodiments of the present disclosure, in the case that one of the cloud SIM cards is detected to encounter a failure (e.g., no signal or data transmission failure), the Ki card at the corresponding position is activated. Upon successful registration of the Ki card, the registration of the cloud SIM card is then completed. Since the Ki card at the position of the failed cloud SIM card homes to the operator of the other cloud SIM card, it is ensured that the Ki card and the cloud SIM card involved in authentication communication home to the same operator, such that it is ensured that the network is registrable and capable of carrying out data communication.

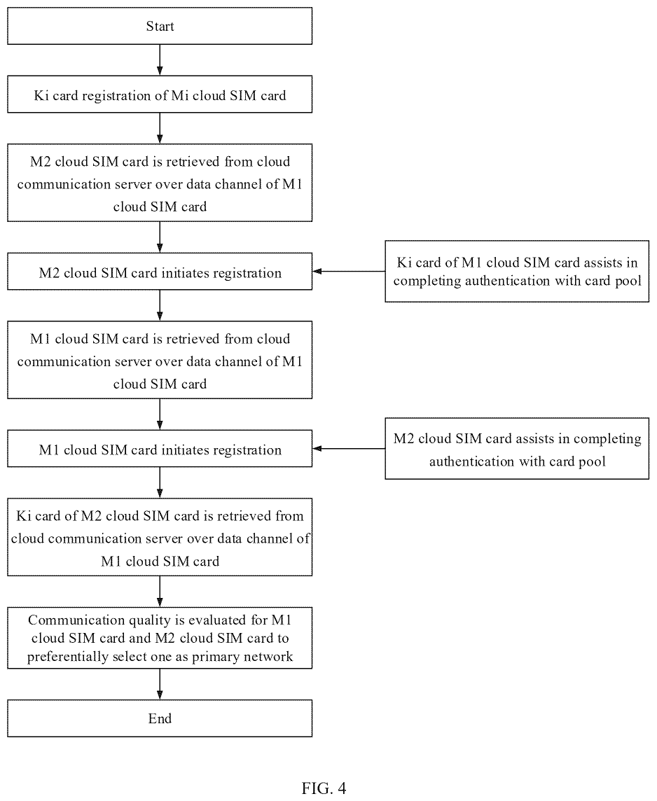

A dual SIM card registration process according to the embodiments of the present disclosure is described hereinafter with reference to FIG. 4.

Using the Ki card in the electronic device, the M1 cloud SIM card is registered with the network.

Retrieval of the M2 cloud SIM card (the second cloud SIM card as mentioned above) from the cloud communication server over the data channel of the M1 cloud SIM card: The cloud communication server contains information about SIM cards from a card pool server and assigns a cloud SIM card that homes to the same operator as the Ki card of the MI cloud SIM card for registration of the M2 cloud SIM card.

Registration initiated by the M2 cloud SIM card: In the case that the M2 cloud SIM card initiates registration, the authentication request is sent to the card pool over a data connection of the Ki card of the M1 cloud SIM card, and the authentication response data returned from the card pool is retrieved to the electronic device and sent back to the network over the M2 cloud SIM card, such that the registration is completed.

Retrieval of the M1 cloud SIM card (the first cloud SIM card as mentioned above) from the cloud communication server over the data channel of the M2 cloud SIM card: The M1 cloud SIM card data is retrieved from the cloud communication server over a data connection established by the M2 cloud SIM card.

Registration initiated by the M1 cloud SIM card: The Ki card of the original M1 cloud SIM card is detached, and the card information is stored in the electronic device. At the same time, the cloud SIM card initiates registration. The authentication is completed with the card pool over the data connection of the M2 cloud SIM card. The authentication request is sent over the data connection of the M2 cloud SIM card, and the authentication response data returned by the card pool is retrieved to the electronic device and sent back to the network over the M1 cloud SIM card, such that the registration is completed.

Retrieval of the Ki card of the M2 cloud SIM card from the cloud communication server over the data channel of the M1 cloud SIM card: Upon completion of the registration of the M1 cloud SIM card, the Ki card of the M2 cloud SIM card that homes to the same operator as the M1 cloud SIM card is retrieved from the cloud communication server and stored in the electronic device. This ensures that, in case of a failure with the M2 cloud SIM card, the Ki card of the M2 cloud SIM card is capable of assisting the M1 cloud SIM card in completing authentication.

Network quality assessment of the M1 and M2 cloud SIM cards and preferential selection of the network: The network quality of the M1 and M2 cloud SIM cards is assessed by evaluating access to the primary destination address. The network with the better quality is preferentially selected to serve as the primary network.

The dual cloud SIM card network monitoring and the cloud SIM card switching communication process according to the embodiments of the present disclosure are described in detail hereinafter.

In step 201, traffic consumption over a time period is monitored. In the case that the traffic consumption exceeds a predetermined threshold, the network is normal; and otherwise, the network is abnormal and step 202 is performed.

In practical applications, the traffic consumption within a time period T1 is monitored to determine whether the traffic consumption exceeds a predetermined threshold F. The parameter T1 may be configured (60 seconds by default, which is adjustable), and the traffic threshold F (100 Kbit by default, which is adjustable). In the case that the traffic exceeds 100 Kbit within 60 seconds, the network is considered normal; and otherwise, the network is flagged for further detection.

In step 202, network detection is performed for the primary cloud SIM card. In the case that data communication of the primary cloud SIM card is normal, step 203 is performed. In the case that data communication of the primary cloud SIM card is abnormal, the operator of the cloud SIM card is switched and step 204 is performed.

In practical applications, a ping test and a network speed test are performed for the network of the primary cloud SIM card, and a packet loss, a delay, and the like are checked by pinging a generic address, and data uploading and downloading are performed to check whether the network condition meet expectations. In the case that the network does not meet expectations, it may be determined that the network of the primary cloud SIM card is abnormal, and the data link is switched to the backup cloud SIM card. In the case that the network of the primary cloud SIM card is normal and meets expectations, the primary cloud SIM card data link is continuously in use.

In step 203, in the case that the primary cloud SIM card data is normal, the data link of the primary cloud SIM card is continuously in used. In an idle period of the data traffic, a data link of the backup cloud SIM card is monitored within a monitoring period T2 of the backup cloud SIM card. In the case that the backup cloud SIM card is normal, no operation is performed. In the case that the backup cloud SIM card data is abnormal, the operator of the cloud SIM card is switched and step 205 is performed.

During use of the data traffic, the data link of the backup cloud SIM card is not monitored. In the case that the idle period reaches a time period of 3 Ts, the monitoring period T2 of the backup cloud SIM card is initiated (5 minutes by default, which is adjustable; this means two backups of the data link of the cloud SIM card should be at least 5 minutes apart; and in the case that the primary data is continuously in use, the monitoring period is delayed), and the data link of the backup cloud SIM card is monitored.

Data link monitoring for the backup cloud SIM card: a ping test or a network speed test is performed for the network of the backup cloud SIM card, and a packet loss, a delay, and the like are checked by pinging a generic address, and data uploading and downloading are performed to check whether the network condition meet expectations. In the case that the network does not meet expectations, it may be determined that the network of the backup cloud SIM card is abnormal, and the data link is switched to the primary cloud SIM card for the next data monitoring period. In the case that the network of the backup cloud SIM card is normal and meets expectations, the backup cloud SIM card data link is continuously in use.

In step 204, the data link of the electronic device is switched to the backup cloud SIM card, and a replacement primary cloud SIM card is retrieved from the cloud communication server over the data channel of the backup cloud SIM card. The replacement primary cloud SIM card is then registered. The registration authentication request is sent over the data channel of the backup cloud SIM card to the card pool. Once authentication is successful, the replacement primary cloud SIM card is used for communication, and the corresponding Ki card from the same operator is retrieved. Dual-cloud SIM card communication is carried out using both the backup cloud SIM card and the replacement primary cloud SIM card.

In this step, a third cloud SIM card from operator C, different from operator A of the primary cloud SIM card A and operator B of the backup cloud SIM card, is retrieved from the cloud communication server to replace the primary cloud SIM card.

Based on the backup cloud SIM card and the replacement primary cloud SIM card, dual-cloud SIM card communication is carried out. The network quality of both the replacement primary cloud SIM card and the backup cloud SIM card is evaluated, and the better network is selected to serve as the primary network. The two cloud SIM cards function as primary and backup SIM cards for each other.

In step 205, the data link of the electronic device is switched to the primary cloud SIM card, and a replacement backup cloud SIM card is retrieved from the cloud communication server over the data channel of the primary cloud SIM card. The replacement backup cloud SIM card is then registered. The registration authentication request is sent over the data channel of the primary cloud SIM card to the card pool. Once authentication is successful, the replacement backup cloud SIM card is used for communication, and the corresponding Ki card from the same operator is retrieved. Dual-cloud SIM card communication is carried out using both the primary cloud SIM card and the replacement backup cloud SIM card.

In this step, a fourth cloud SIM card from operator C, different from operator A of the primary cloud SIM card A and operator B of the backup cloud SIM card, is retrieved from the cloud communication server to replace the backup cloud SIM card.

Based on the primary cloud SIM card and the replacement backup cloud SIM card, dual-cloud SIM card communication is carried out. The network quality of both the replacement backup cloud SIM card and the primary cloud SIM card is evaluated, and the better network is selected to serve as the primary network. The two cloud SIM cards function as primary and backup SIM cards for each other.

In the embodiments of the present disclosure, upon power-on of the electronic device, a second cloud SIM card homing to the same operator as the first authentication module is assigned to the electronic device. Upon successful registration of the second cloud SIM card, the second cloud SIM card is employed for connection to the cloud communication server. The first authentication module is detached, and the first cloud SIM card with second-optimal signals is re-assigned to the electronic device. The authentication of the first cloud SIM card is completed using the second cloud SIM card, and the first cloud SIM card is successfully registered. This enables dual-cloud SIM card registration for both the first and second authentication modules, such that data services are provided using the cloud SIM card with the optimal network quality within the same time period. Where the cloud SIM card in use experiences a failure, the electronic device is switched to the other cloud SIM card, such that data services are not interrupted. This enables dual operator network backup, and hence improves the reliability of data services.

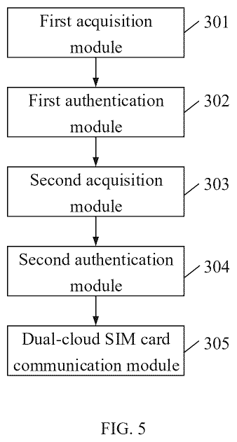

FIG. 5 is a schematic structural diagram of an electronic device according to some embodiments of the present disclosure. The electronic device includes:
a first acquisition module 301, configured to acquire card information of a second cloud SIM card from a cloud communication server, wherein the second cloud SIM card and a first authentication module 302 home to a same network operator;
the first authentication module 302, configured to authenticate card information of the second cloud SIM card acquired by the first acquisition module 301, and detach the first authentication module in response to a successful authentication on the card information of the second cloud SIM card;
a second acquisition module 303, configured to acquire card information of a first cloud SIM card from the cloud communication server, wherein the first cloud SIM card and a second authentication module home to a same network operator;
the second authentication module 304, configured to authenticate, based on the second cloud SIM card, the card information of the first cloud SIM card acquired by the second acquisition module 303; and
a dual-cloud SIM card communication module 305, configured to carry out the dual-cloud SIM card communication using the first cloud SIM card and the second cloud SIM card in response to a successful authentication on the card information of the first cloud SIM card by the second authentication module 304.

The first authentication module 302 is further configured to send a first authentication request to a card pool based on data of the first authentication module to acquire an authentication result for the card information of the second cloud SIM card from the card pool based on the data of the first authentication module.

Correspondingly, the second authentication module is configured to send a second authentication request to the card pool based on data of the second cloud SIM card to acquire an authentication result for the card information of the first cloud SIM card from the card pool.

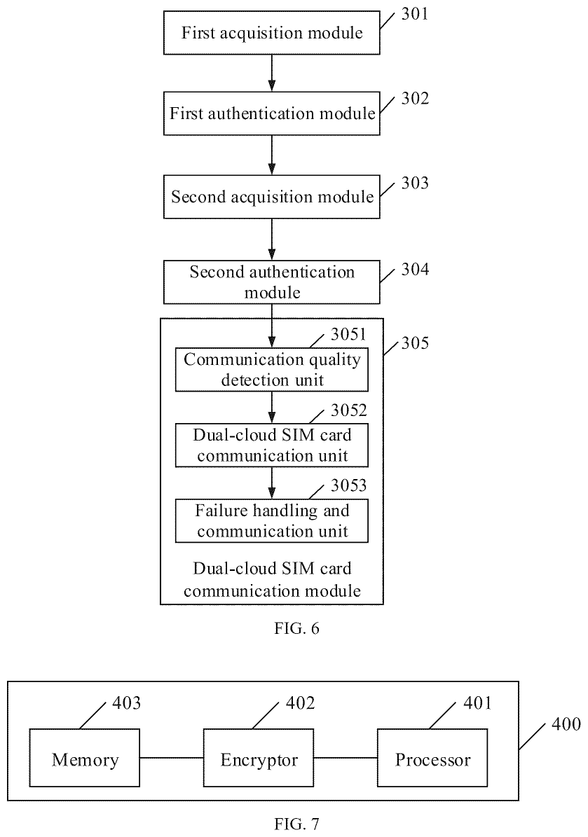

As illustrated in a schematic structural diagram of an electronic device in FIG. 6, the dual-cloud SIM card communication module 305 includes a communication quality detection unit 3051, and a dual-cloud SIM card communication unit 3052.

The communication quality detection unit 3051 is configured to monitor first communication quality data of the first cloud SIM card and second communication quality data of the second cloud SIM card.

The dual-cloud SIM card communication unit 3052 is configured to carry out data communication using the first cloud SIM card in a case that the first communication quality data is superior over the second communication quality data, or carry out data communication based on the second cloud SIM card in a case that the first communication quality data is not superior over the second communication quality data.

In some embodiments, the dual-cloud SIM card communication module further includes a failure handling and communication unit 3053, configured to switch a data link to the second cloud SIM card in response to the communication quality detection unit 3051 monitoring that the first communication quality data of the first cloud SIM card is abnormal; and
correspondingly, the electronic device further includes a third acquisition module 306 and a third authentication module 307.

The third acquisition module 306 is configured to acquire card information of a third cloud SIM card from the cloud communication server.

The third authentication module 307 is configured to send a third authentication request to the card pool based on data of the second cloud SIM card to acquire an authentication result for the card information of the third cloud SIM card from the card pool.

The failure handling and communication unit 3053 is further configured to carry out the dual-cloud SIM card communication based on the third cloud SIM card and the second cloud SIM card in response to the authentication result for the card information of the third cloud SIM card indicating a successful authentication.

In the embodiments of the present disclosure, the first cloud SIM card and the second cloud SIM card home to different network operators. The first authentication module and the second authentication module include, but are not limited to, authentication modules for a physical SIM card, an eSIM card, and a soft SIM card.

In the embodiments of the present disclosure, upon power-on of the electronic device, a second cloud SIM card homing to the same operator as the first authentication module is assigned to the electronic device. Upon successful registration of the second cloud SIM card, the second cloud SIM card is employed for connection to the cloud communication server. The first authentication module is detached, and the first cloud SIM card with second-optimal signals is re-assigned to the electronic device. The authentication of the first cloud SIM card is completed using the second cloud SIM card, and the first cloud SIM card is successfully registered. This enables dual-cloud SIM card registration for both the first and second authentication modules, such that data services are provided using the cloud SIM card with the optimal network quality within the same time period. Where the cloud SIM card in use experiences a failure, the electronic device is switched to the other cloud SIM card, such that data services are not interrupted. This enables dual operator network backup, and hence improves the reliability of data services.

FIG. 7 is a schematic structural diagram of a device for dual-cloud SIM card communication according to some embodiments of the present disclosure.

The device 400 for dual-cloud SIM card communication includes a processor 401, an encryptor 402, a memory 403, and one or more computer programs that are stored in the memory and runnable on the processor, wherein the processor 401 is configured to load and run the one or more computer programs to cause the device 400 to perform the method for dual-cloud SIM card communication as described in the above embodiments.

For example, the processor 401 is a central processing unit (CPU) or the like. The memory 403 may include a random access memory, a flash memory, read-only memory, a programmable read-only memory, a non-volatile memory, a register, and the like. An encryption token is embedded in the encryptor 402. The memory 403 may store one or more executable instructions. The processor 401 may execute the one or more executable instructions stored in the memory 403 to perform the processes described herein.

Additionally, some embodiments of the present disclosure further provide a machine-readable storage medium. The machine-readable storage medium may store one or more executable instructions, which, when loaded and executed by a machine, cause the machine to perform the specific processes described above with reference to the method embodiments.

For example, the machine-readable storage medium may include, but is not limited to, a random access memory (RAM), a read-only memory (ROM), an electrically-erasable programmable read-only memory (EEPROM), a static random access memory (SRAM), a hard disk, a flash memory, and the like.

Those skilled in the art may envisage that various exemplary units and algorithm steps described with reference to the embodiments of the present disclosure given herein may be practiced in the form of electronic hardware or a combination of software and electronic hardware. Whether such functions are implemented in the form of software or hardware depends on the specific application of the technical solutions and the design restrictions. Those skilled in the art may implement the described functions by using different methods for each specific application. However, such implementation shall not be deemed as going beyond the scope of the present disclosure.

In several embodiments of the present disclosure, it should be understood that the disclosed system, apparatus, and method may be implemented in other manners. For example, categorization of the functional units in the present disclosure is merely made in terms of logical functionality. In practice, the categorization of the apparatus may also be achieved in any other form. For example, a plurality of units or components may be combined or integrated into another system. Additionally, the coupling between the various units may be either direct coupling or indirect coupling. In addition, functional units in the embodiments of the present disclosure may be integrated into one processing unit, or may be separate physical units.

In the case that the functions are implemented in a form of a software functional unit and sold or used as an independent product, the units may be stored in a machine-readable storage medium. Therefore, the technical solutions of the present disclosure may be embodied in the form of a software product. This software product may be stored in a machine-readable storage medium and may include several instructions to cause an electronic device to perform all or part of the processes described in the embodiments of the present disclosure. The storage medium includes a ROM, a RAM, a magnetic disk, a compact disc read-only memory (CD-ROM), or the like medium which is capable of storing program code.

Described above are merely specific embodiments of the present disclosure, and the scope of protection of the present disclosure are not limited thereto. Variations or substitutions that may be made by those skilled in the art within the technical scope disclosed in the present disclosure shall also fall within the scope of protection of the present disclosure.

What is claimed is:

1. A method for dual-cloud subscriber identification module (SIM) card communication, applicable to an electronic device, the electronic device being equipped with a first authentication module and a second authentication module, the method comprising:
acquiring card information of a second cloud SIM card from a cloud communication server, authenticating the card information of the second cloud SIM card based on the first authentication module, and detaching the first authentication module in response to a successful authentication on the card information of the second cloud SIM card, wherein the second cloud SIM card and the first authentication module home to a same first network operator;
acquiring card information of a first cloud SIM card from the cloud communication server, wherein the first cloud SIM card and the second authentication module home to a same second network operator; and
authenticating the card information of the first cloud SIM card based on the second cloud SIM card, and carrying out the dual-cloud SIM card communication using the first cloud SIM card and the second cloud SIM card in response to a successful authentication on the card information of the first cloud SIM card.

2. The method according to claim 1, wherein authenticating the card information of the second cloud SIM card using the first authentication module comprises:
sending a first authentication request to a card pool based on data of the first authentication module to acquire an authentication result for the card information of the second cloud SIM card from the card pool based on the data of the first authentication module; and
correspondingly, authenticating the card information of the first cloud SIM card based on the second cloud SIM card comprises:
sending a second authentication request to the card pool based on data of the second cloud SIM card to acquire an authentication result for the card information of the first cloud SIM card from the card pool.

3. The method according to claim 2, wherein carrying out the dual-cloud SIM card communication using the first cloud SIM card and the second cloud SIM card comprises:
monitoring first communication quality data of the first cloud SIM card and second communication quality data of the second cloud SIM card; and
carrying out data communication using the first cloud SIM card when the first communication quality data is superior over the second communication quality data, or carrying out data communication based on the second cloud SIM card when the first communication quality data is not superior over the second communication quality data.

4. The method according to claim 3, further comprising:
switching a data link to the second cloud SIM card in response to monitoring that the first communication quality data of the first cloud SIM card is abnormal;
acquiring card information of a third cloud SIM card from the cloud communication server, and sending a third authentication request to the card pool based on the data of the second cloud SIM card to acquire an authentication result for the card information of the third cloud SIM card from the card pool; and
carrying out the dual-cloud SIM card communication based on the third cloud SIM card and the second cloud SIM card in response to the authentication result for the card information of the third cloud SIM card indicating a successful authentication.

5. The method according to claim 4, wherein when the card information of the first cloud SIM card is successfully authenticated, the method further comprises: acquiring, based on a data channel of the first cloud SIM card, the second authentication module homing to the same second network operator as the first cloud SIM card from the cloud communication server; and
sending the third authentication request to the card pool based on the data of the second cloud SIM card comprises:
sending the third authentication request to the card pool based on the data of the second cloud SIM card and the second authentication module to acquire the authentication result for the card information of the third cloud SIM card from the card pool based on the second authentication module.

6. The method according to claim 4, wherein carrying out the dual-cloud SIM card communication based on the third cloud SIM card and the second cloud SIM card comprises:
monitoring third communication quality data of the third cloud SIM card and the second communication quality data of the second cloud SIM card; and
carrying out data communication based on the third cloud SIM card when the third communication quality data is superior over the second communication quality data, or carrying out data communication based on the second cloud SIM card when the third communication quality data is not superior over the second communication quality data.

7. The method according to claim 1, wherein the first authentication module and the second authentication module comprise authentication modules for a physical SIM card, an eSIM card, and a soft SIM card.

8. The method according to claim 1, wherein the first cloud SIM card and the second cloud SIM card home to different network operators.

9. An electronic device, comprising:
a first acquisition module, configured to acquire card information of a second cloud SIM card from a cloud communication server, wherein the second cloud SIM card and a first authentication module home to a same first network operator;
the first authentication module, configured to authenticate the card information of the second cloud SIM card acquired by the first acquisition module, and detach the first authentication module in response to a successful authentication on the card information of the second cloud SIM card;
a second acquisition module, configured to acquire card information of a first cloud SIM card from the cloud communication server, wherein the first cloud SIM card and a second authentication module home to a same second network operator;
the second authentication module, configured to authenticate, based on the second cloud SIM card, the card information of the first cloud SIM card acquired by the second acquisition module; and
a dual-cloud SIM card communication module, configured to carry out the dual-cloud SIM card communication using the first cloud SIM card and the second cloud SIM card in response to a successful authentication on the card information of the first cloud SIM card by the second authentication module.

10. The electronic device according to claim 9, wherein the first authentication module is configured to send a first authentication request to a card pool based on data of the first authentication module to acquire an authentication result for the card information of the second cloud SIM card from the card pool based on the data of the first authentication module; and
correspondingly, the second authentication module is configured to send a second authentication request to the card pool based on data of the second cloud SIM card to acquire an authentication result for the card information of the first cloud SIM card from the card pool.

11. The electronic device according to claim 10, wherein the dual-cloud SIM card communication module comprises a communication quality detection unit, and a dual-cloud SIM card communication unit; wherein
the communication quality detection unit is configured to monitor first communication quality data of the first cloud SIM card and second communication quality data of the second cloud SIM card; and
the dual-cloud SIM card communication unit is configured to carry out data communication using the first cloud SIM card when the first communication quality data is superior over the second communication quality data, or carry out data communication based on the second cloud SIM card when the first communication quality data is not superior over the second communication quality data.

12. The electronic device according to claim 11, wherein the dual-cloud SIM card communication module further comprises a failure handling and communication unit, configured to switch a data link to the second cloud SIM card in response to the communication quality detection unit monitoring that the first communication quality data of the first cloud SIM card is abnormal; and
correspondingly, the electronic device further comprises a third acquisition module and a third authentication module; wherein
the third acquisition module is configured to acquire card information of a third cloud SIM card from the cloud communication server;
the third authentication module is configured to send a third authentication request to the card pool based on data of the second cloud SIM card to acquire an authentication result for the card information of the third cloud SIM card from the card pool; and
the failure handling and communication unit is further configured to carry out the dual-cloud SIM card communication based on the third cloud SIM card and the second cloud SIM card in response to the authentication result for the card information of the third cloud SIM card indicating a successful authentication.

13. The electronic device according to claim 9, wherein the first cloud SIM card and the second cloud SIM card home to different network operators.

14. The electronic device according to claim 9, wherein the first authentication module and the second authentication module comprise authentication modules for a physical SIM card, an eSIM card, and a soft SIM card.

15. A device for dual-cloud SIM card communication, comprising:
a processor, an encryptor, a memory, and one or more computer programs, wherein the one or more computer programs are stored in the memory and runnable on the processor; wherein the one or more computer programs, when loaded and run by the processor, cause the processor to perform the method according to claim 1.

16. A machine-readable storage medium storing one or more executable instructions, wherein the one or more executable instructions, when loaded and executed by a machine, cause the machine to perform the method according to claim 1.

17. The device according to claim 15, wherein in the method, authenticating the card information of the second cloud SIM card using the first authentication module comprises:
sending a first authentication request to a card pool based on data of the first authentication module to acquire an authentication result for the card information of the second cloud SIM card from the card pool based on the data of the first authentication module; and
correspondingly, authenticating the card information of the first cloud SIM card based on the second cloud SIM card comprises:
sending a second authentication request to the card pool based on data of the second cloud SIM card to acquire an authentication result for the card information of the first cloud SIM card from the card pool.

18. The device according to claim 17, wherein in the method, carrying out the dual-cloud SIM card communication using the first cloud SIM card and the second cloud SIM card comprises:
monitoring first communication quality data of the first cloud SIM card and second communication quality data of the second cloud SIM card; and
carrying out data communication using the first cloud SIM card when the first communication quality data is superior over the second communication quality data, or carrying out data communication based on the second cloud SIM card when the first communication quality data is not superior over the second communication quality data.

19. The device according to claim 18, wherein the method further comprises:
switching a data link to the second cloud SIM card in response to monitoring that the first communication quality data of the first cloud SIM card is abnormal;
acquiring card information of a third cloud SIM card from the cloud communication server, and sending a third authentication request to the card pool based on the data of the second cloud SIM card to acquire an authentication result for the card information of the third cloud SIM card from the card pool; and
carrying out the dual-cloud SIM card communication based on the third cloud SIM card and the second cloud SIM card in response to the authentication result for the card information of the third cloud SIM card indicating a successful authentication.

20. The device according to claim 19, wherein in the method, when the card information of the first cloud SIM card is successfully authenticated, the method further comprises: acquiring, based on a data channel of the first cloud SIM card, the second authentication module homing to the same second network operator as the first cloud SIM card from the cloud communication server; and
sending the third authentication request to the card pool based on the data of the second cloud SIM card comprises:
sending the third authentication request to the card pool based on the data of the second cloud SIM card and the second authentication module to acquire the authentication result for the card information of the third cloud SIM card from the card pool based on the second authentication module.
